(19) United States
(12) Patent Application Publication
(10) Pub. No.: US 2006/0149652 A1
(43) Pub. Date: Jul. 6, 2006

(54) Receiving bid requests and pricing bid responses for potential grid job submissions within a grid environment

(76) Inventors: Craig William Fellenstein, Brookfield, CT (US); Rick Allen Hamilton II, Charlottesville, VA (US); Joshy Joseph, Poughkeepsie, NY (US); James W. Seaman, Falls Church, VA (US)

Correspondence Address: IBM CORP (AP);C/O AMY PATTILLO, P. O. BOX 161327, AUSTIN, TX, 78716, US

(21) Appl. No.: 11/031,489

(22) Filed: Jan. 6, 2005

(51) Int. Cl. G06Q 40/00

(52) U.S. Cl. 705/35

(57) ABSTRACT

A computer-implemented method, system, and program for receiving bid requests and pricing bid responses for potential grid job submissions within a grid environment are provided. The grid environment includes multiple grid resource nodes available for executing a grid job at a price. Clients submit bid requests for potential grid job submissions to a bid request portal of the grid environment. A workload factor is calculated for each bid request that indicates the estimated resource usage at a resource work unit level for the potential grid job. Next, a cost calculator calculates a price for the potential grid job submission based on the predicted workload factor and a cost per granular work unit, such that the price is available for an automated response to the bid request. The cost per resource work unit may be calculated based on the current and predicted workload on the resources available in the grid environment. Pricing may also be adjusted by available discounting or contractual pricing restraints.

### CROSS-REFERENCE TO RELATED APPLICATIONS

The present application is related to the following co-pending applications:

(1) U.S. patent application Ser. No. ______ (Attorney Docket No. AUS920040501US1); and

(2) U.S. patent application Ser. No. ______ (Attorney Docket No. AUS920040567US1).

### BACKGROUND OF THE INVENTION

1. Technical Field

The present invention relates in general to improved grid computing and in particular to responding to bid requests for potential grid job submissions. Still more particularly, the present invention relates to automated reception of bid requests for potential grid job submissions and automated calculation of a price at a granular work unit level for a bid response based on the predicted workload requirements of a bid request, such that a grid vendor automatically responds to bid requests with a request specific price.

2. Description of the Related Art

Ever since the first connection was made between two computer systems, new ways of transferring data, resources, and other information between two computer systems via a connection continue to develop. In typical network architectures, when two computer systems are exchanging data via a connection, one of the computer systems is considered a client sending requests and the other is considered a server processing the requests and returning results. In an effort to increase the speed at which requests are handled, server systems continue to expand in size and speed. Further, in an effort to handle peak periods when multiple requests are arriving every second, server systems are often joined together as a group and requests are distributed among the grouped servers. Multiple methods of grouping servers have developed such as clustering, multi-system shared data (sysplex) environments, and enterprise systems. With a cluster of servers, one server is typically designated to manage distribution of incoming requests and outgoing responses. The other servers typically operate in parallel to handle the distributed requests from clients. Thus, one of multiple servers in a cluster may service a client request without the client detecting that a cluster of servers is processing the request.

Typically, servers or groups of servers operate on a particular network platform, such as Unix or some variation of Unix, and provide a hosting environment for running applications. Each network platform may provide functions ranging from database integration, clustering services, and security to workload management and problem determination. Each network platform typically offers different implementations, semantic behaviors, and application programming interfaces (APIs).

Merely grouping servers together to expand processing power, however, is a limited method of improving efficiency of response times in a network. Thus, increasingly, within a company network, rather than just grouping servers, servers and groups of server systems are organized as distributed resources. There is an increased effort to collaborate, share data, share cycles, and improve other modes of interaction among servers within a company network and outside the company network. Further, there is an increased effort to outsource nonessential elements from one company network to that of a service provider network. Moreover, there is a movement to coordinate resource sharing between resources that are not subject to the same management system, but still address issues of security, policy, payment, and membership. For example, resources on an individual's desktop are not typically subject to the same management system as resources of a company server cluster. Even different administrative groups within a company network may implement distinct management systems.

The problems with decentralizing the resources available from servers and other computing systems operating on different network platforms, located in different regions, with different security protocols and each controlled by a different management system, has led to the development of Grid technologies using open standards for operating a grid environment. Grid environments support the sharing and coordinated use of diverse resources in dynamic, distributed, virtual organizations. A virtual organization is created within a grid environment when a selection of resources, from geographically distributed systems operated by different organizations with differing policies and management systems, is organized to handle a job request.

While the open standards defining grid technology facilitate sharing and coordination of diverse resources in dynamic, distributed, virtual organizations, grid standards do not solve all of the problems associated with actually determining how to inform a client of a cost for use of grid resources or for estimating a price for use of grid resources. For example, a grid vendor may build a grid environment of grid resources available for use on a per job basis, per hour basis, or other availability however, merely building a grid environment does not solve the problem of how to price the use of the grid resources or inform potential clients of a price for use of the grid resources for a particular grid job. Further, for a grid vendor to maximize use of the grid resources within the grid environment, pricing grid jobs merely by the hour or by the number of grid jobs is limited; it would be advantageous to price use of the grid resources based on both the characteristics of the grid job and the current and future workload on the grid resources, rather than just providing static or flat rate pricing. Moreover, as the number of bid requests received by a grid vendor escalate, it would be advantageous to automate pricing calculations for responses to bid requests for a potential grid job.

Therefore, in view of the foregoing, there is a need for a computer automated method, system, and program for receiving and responding to bid requests for a potential grid job submission to a grid vendor and, in particular, for automatically pricing potential grid jobs based on the job characteristics and the predicted workload of grid resources required for the potential grid job available to the grid vendor. In addition, there is a need to automatically adjust pricing based on current and predicted workload on the resources. In particular, there is a need for a computer automated method, system, and program for automatically pricing potential grid jobs by type of resource usage and at a granular work unit level for each type of resource.

### SUMMARY OF THE INVENTION

In view of the foregoing, the present invention in general provides for improved grid computing and in particular to responding to bid requests for potential grid job submissions. Still more particularly, the present invention relates to automated reception of bid requests for potential grid job submissions and automated calculation of a price at a granular work unit level for a bid response based on the predicted workload requirements of a bid request, such that a grid vendor automatically responds to bid requests with a request specific price.

In one embodiment, a grid environment enables receipt of a bid request for a potential grid job submission via a grid environment submission portal. The grid environment may be a grid farm of grid resources built providing an external grid environment for handling grid jobs. The grid environment may also be a grid grouping within an enterprise grid environment, where a cost per grid job executing in the grid grouping is calculated.

A workload calculator predicts a workload factor for the potential grid job submission based on the characteristics of the potential grid job submission. The workload factor is based on at least one type of granular work unit, such as a number of bytes of memory.

A cost calculator calculates a price for the potential grid job submission based on the predicted workload factor and a cost per granular work unit, such that the price is available for an automated response to the bid request. The cost per granular work unit may be calculated based on the current and predicted workload on the resources available in the grid environment. In addition, the cost per granular work unit may be calculated for use of a particular type of resource within the grid environment. A subprice for each type of resource is first calculated and then a total price for the grid job is accumulated.

The calculated price may also be adjusted by a discount available for the potential grid job submission. A discount may be available, for example, if the potential grid job submission is of a particular type or uses a particular subsystem of resources or if the client submitting the bid request has submitted a particular volume of grid jobs within a particular time, and other discounting factors.

In addition, the calculated prices may be adjusted by a contracted price specified for the client submitting the bid request. A contract price may be specified according to type of grid job, type of resources used by a grid job, and other contractually agreed to pricing terms.

According to another embodiment, when a previously bid on grid job is received at a grid environment, closed-loop automated management of the grid job is triggered. First, when the grid job is received at a grid portal of the grid environment from a client, the bid request and bid previously agreed to for the job are accessed. Next, the bid is analyzed to determine a resource node requirement for the grid job. Then, a current activity level is the grid environment is surveyed to detect whether a selection of available resource nodes meeting the resource node requirement are available. If a selection of available resource nodes meeting the resource node requirement are available, then the selection of available resource nodes are allocated to handle the grid job and the job is routed to the allocated selection of available resource nodes. Then, the status of the grid job is monitored according to the workload detected from the allocated selection of available resource nodes. Responsive to verifying a completion of the grid job, at least one result of the grid job is routed to the client via, such that automated management in a closed-loop path is provided for each grid job received via said grid portal.

### BRIEF DESCRIPTION OF THE DRAWINGS

The novel features believed aspect of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system which may be implemented in a grid environment and in which the present invention may be implemented;

FIG. 2 is block diagram illustrating one embodiment of the general types of components within a grid environment;

FIG. 3 is a block diagram depicting one example of an architecture that may be implemented in a grid environment;

FIG. 4 is a block diagram depicting one illustration of a logical representation of the grid management system within a grid environment;

FIG. 5 is a block diagram depicting an automated closed loop grid management system for handling bid requests and grid jobs in accordance with the present invention;

FIG. 6 is a block diagram depicting a grid pricing service in accordance with the method, system, and program of the present invention;

FIG. 7 is an illustrative example depicting a price calculation for a bid request in accordance with the method, system, and program of the present invention;

FIG. 8 is a high level logic flowchart depicting a process and program for controlling receipt and response to bid requests for a potential grid job submission to a particular grid environment in accordance with the method, system, and program of the present invention;

FIG. 9 is a high level logic flowchart depicting a process and program for automatically determining a price for a potential job described in a bid request received by a grid vendor in accordance with the method, system, and program of the present invention; and

FIG. 10 is a high level logic flowchart depicting a process and program for providing automated, closed-loop management of a grid job received at a grid management system in accordance with the method, system, and program of the present invention.

### DETAILED DESCRIPTION OF THE PREFERRED EMBODIMENT

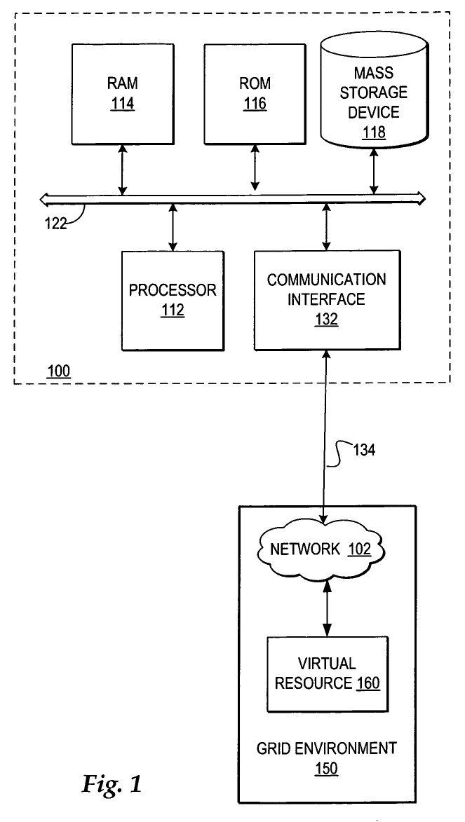

Referring now to the drawings and in particular to FIG. 1, there is depicted one embodiment of a computer system which may be implemented in a grid environment and in which the present invention may be implemented. As will be further described, the grid environment includes multiple computer systems managed to provide resources. Additionally, as will be further described, the present invention may be executed in a variety of computer systems, including a variety of computing systems, mobile systems, and electronic devices operating under a number of different operating systems managed within a grid environment.

In one embodiment, computer system 100 includes a bus 122 or other device for communicating information within computer system 100, and at least one processing device such as processor 112, coupled to bus 122 for processing information. Bus 122 may include low-latency and higher latency paths connected by bridges and adapters and controlled within computer system 100 by multiple bus controllers. When implemented as a server system, computer system 100 typically includes multiple processors designed to improve network servicing power.

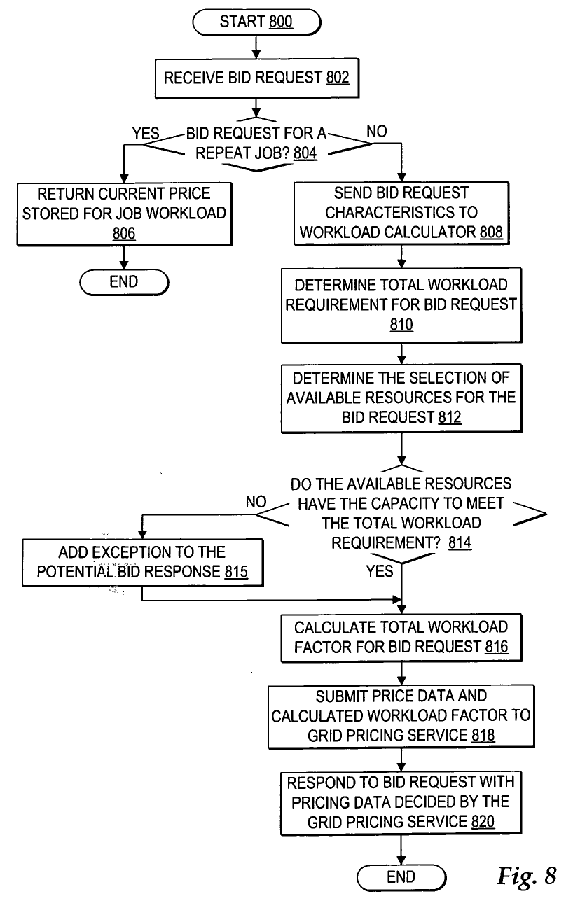

Processor 112 may be a general-purpose processor such as IBM's PowerPC™ processor that, during normal operation, processes data under the control of operating system and application software accessible from a dynamic storage device such as random access memory (RAM) 114 and a static storage device such as Read Only Memory (ROM) 116. The operating system may provide a graphical user interface (GUI) to the user. In one embodiment, application software contains machine executable instructions that when executed on processor 112 carry out the operations depicted in the flowcharts of FIGS. 8, 9, and 10 and others operations described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 100 to perform a process according to the present invention. The term “machine-readable medium” as used herein includes any medium that participates in providing instructions to processor 112 or other components of computer system 100 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the present embodiment, an example of a non-volatile medium is mass storage device 118 which as depicted is an internal component of computer system 100, but will be understood to also be provided by an external device. Volatile media include dynamic memory such as RAM 114. Transmission media include coaxial cables, copper wire or fiber optics, including the wires that comprise bus 122. Transmission media can also take the form of acoustic or light waves, such as those generated during radio frequency or infrared data communications.

Moreover, the present invention may be downloaded as a computer program product, wherein the program instructions may be transferred from a remote virtual resource, such as a virtual resource 160, to requesting computer system 100 by way of data signals embodied in a carrier wave or other propagation medium via a network link 134 (e.g. a modem or network connection) to a communications interface 132 coupled to bus 122. Virtual resource 160 may include a virtual representation of the resources accessible from a single system or systems, wherein multiple systems may each be considered discrete sets of resources operating on independent platforms, but coordinated as a virtual resource by a grid manager. Communications interface 132 provides a two-way data communications coupling to network link 134 that may be connected, for example, to a local area network (LAN), wide area network (WAN), or an Internet Service Provider (ISP) that provide access to network 102. In particular, network link 134 may provide wired and/or wireless network communications to one or more networks, such as network 102, through which use of virtual resources, such as virtual resource 160, is accessible as provided within a grid environment 150. Grid environment 150 may be part of multiple types of networks, including a peer-to-peer network, or may be part of a single computer system, such as computer system 100.

As one example, network 102 may refer to the worldwide collection of networks and gateways that use a particular protocol, such as Transmission Control Protocol (TCP) and Internet Protocol (IP), to communicate with one another. Network 102 uses electrical, electromagnetic, or optical signals that carry digital data streams. The signals through the various networks and the signals on network link 134 and through communication interface 132, which carry the digital data to and from computer system 100, are exemplary forms of carrier waves transporting the information. It will be understood that alternate types of networks, combinations of networks, and infrastructures of networks may be implemented.

When implemented as a server system, computer system 100 typically includes multiple communication interfaces accessible via multiple peripheral component interconnect (PCI) bus bridges connected to an input/output controller. In this manner, computer system 100 allows connections to multiple network computers.

Additionally, although not depicted, multiple peripheral components and internal/external devices may be added to computer system 100, connected to multiple controllers, adapters, and expansion slots coupled to one of the multiple levels of bus 122. For example, a display device, audio device, keyboard, or cursor control device may be added as a peripheral component.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

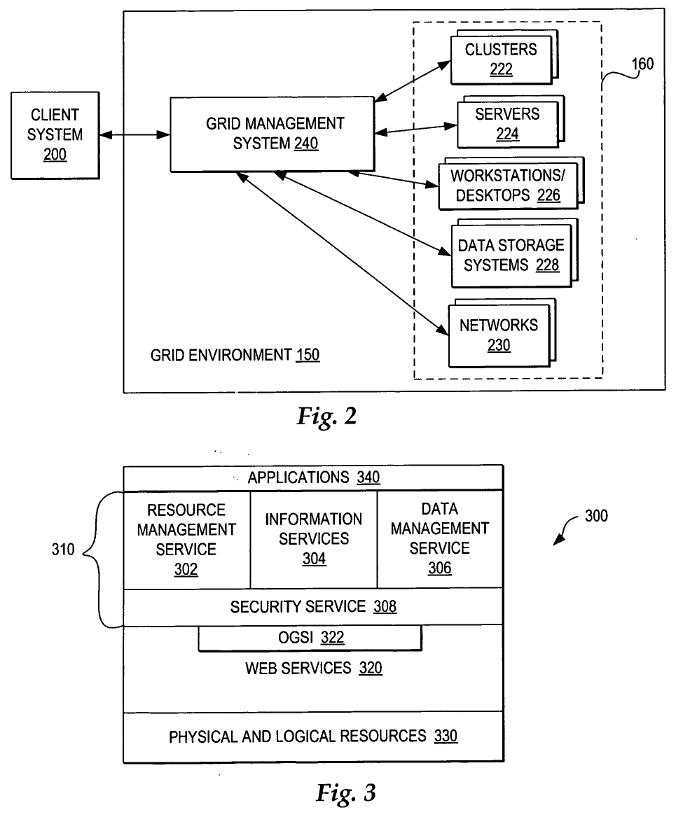

With reference now to FIG. 2, a block diagram illustrates one embodiment of the general types of components within a grid environment. In the present example, the components of a grid environment 150 include a client system 200 interfacing with a grid management system 240 which interfaces with server clusters 222, servers 224, workstations and desktops 226, data storage systems 228, and networks 230. For purposes of illustration, the network locations and types of networks connecting the components within grid environment 150 are not depicted. It will be understood, however, that the components within grid environment 150 may reside atop a network infrastructure architecture that may be implemented with multiple types of networks overlapping one another. Network infrastructure may range from multiple large enterprise systems to a peer-to-peer system to a single computer system. Further, it will be understood that the components within grid environment 150 are merely representations of the types of components within a grid environment. A grid environment may simply be encompassed in a single computer system or may encompass multiple enterprises of systems.

It will be understood that grid environment 150 may be provided by a grid vendor, where a cost for use of resources within grid environment 150 may be calculated based on the amount of time required for a grid job to execute or the actual amount of resources used, for example. In addition, it will be understood that grid environment 150 may include grid resources supplied by a single grid vendor, such as a particular business enterprise, or multiple vendors, where each vendor continues to monitor and manage the vendor's group of resources, but grid management system 240 is able to monitor unintended changes across all the resources, regardless of which vendors provide which resources. Further, it will be understood that although resource discovery mechanisms for discovering available grid resources are not depicted, client system 200 or grid management system 240 may discover grid resources advertised from local and global directories available within and outside of grid environment 150.

The central goal of a grid environment, such as grid environment 150 is organization and delivery of resources from multiple discrete systems viewed as virtual resource 160. Client system 200, server clusters 222, servers 224, workstations and desktops 226, data storage systems 228, networks 230 and the systems creating grid management system 240 may be heterogeneous and regionally distributed with independent management systems, but enabled to exchange information, resources, and services through a grid infrastructure enabled by grid management system 240. Further, server clusters 222, servers 224, workstations and desktops 226, data storage systems 228, and networks 230 may be geographically distributed across countries and continents or locally accessible to one another.

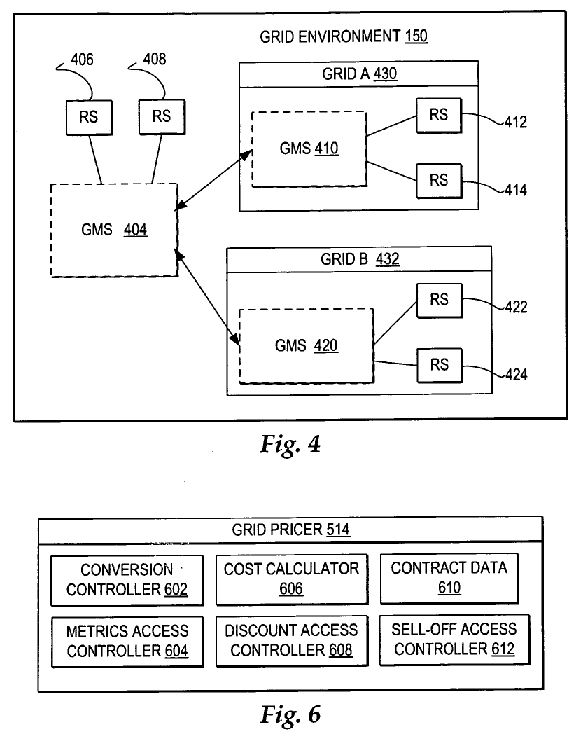

With reference now to FIG. 4, there is depicted one example of a logical representation of grid management system 240 and virtual resource 160 distributed among heterogeneous systems and environments within the grid environment. In the example, grid management system 240 is logically represented as distributed among multiple grid managers (GMs) 404, 410, and 420. Each of GMs 404, 410, and 420 communicate with one another to implement grid management system 240. In particular, each of GMs 404, 410, and 420 may provide monitoring, scheduling, and management to resource nodes (RSs), such as resource nodes 406, 408, 410, 412, 414, 422, and 424 from among virtual resource 160. In one embodiment, resource nodes are groupings of resources already allocated to provide a particular execution platform. For example, a resource node may include a particular type of server already running a particular operating system and a particular application.

Each GM may directly manage access to a selection of resources, but may build an execution environment for a grid job by grouping resources directly managed by multiple grid managers. In the example, GM 404 directly manages RS 406 and RS 408, but may build an execution environment for a grid job by accessing resource nodes managed by GMs 410 and 420. In particular, GM 410 may manage resource nodes 412 and 414 available in Grid A 430 and GM 420 may manage resource nodes 422 and 424 available in Grid B 432.

GM 404, GM 410, GM 420 and all the RSs may be part of a grid environment of resources all owned by a single enterprise or of resources all managed and owned by a single grid vendor. In another example, grid environment 150 may be the environment in which a single enterprise submits grid jobs, but Grid A 430 and Grid B 432 are accessed from grid vendors and incorporated either temporarily or permanently within grid environment 150.

According to one embodiment, GM 404, GM 410, or GM 420 may receive bid requests for potential grid job submissions from a client system outside grid environment 150 or from one of the other GMs within grid environment 150. GM 404, GM 410, or GM 420 may calculate pricing for the bid request based on the characteristics of the potential grid job and the current and predicted workload of the resources. Further, in one example, GM 404 may receive a bid request and determine pricing the particular job for use of RS 406 and RS 408, but may also forward the bid request to GM 410 and GM 420 to determine pricing for use of other resources accessible within grid environment 150.

According to another embodiment, GM 404, GM 410, or GM 420 may receive a previously bid on grid job and allocate an execution environment of resource nodes available to meet the grid job requirements. In particular, GM 404, GM 410, or GM 420 may provide closed-loop management for a grid job to ensure that each grid job received in grid environment 150 is distributed to sufficient resources, processed, and a result returned.

Returning now to FIG. 2, in the example, client system 200 interfaces with grid management system 240. Client system 200 may represent any computing system sending requests to grid management system 240. In particular, client system 200 may send virtual job requests (or requests for a quote (RFQs) and jobs to grid management system 240. Further, while in the present embodiment client system 200 is depicted as accessing grid environment 150 with a request, in alternate embodiments client system 200 may also operate within grid environment 150.

While the systems within virtual resource 160 are depicted in parallel, in reality, the systems may be part of a hierarchy of systems where some systems within virtual resource 160 may be local to client system 200, while other systems require access to external networks. Additionally, it is important to note, that systems depicted within virtual resources 160 may be physically encompassed within client system 200.

To implement grid environment 150, grid management system 240 facilitates grid services. Grid services may be designed according to multiple architectures, including, but not limited to, the Open Grid Services Architecture (OGSA). In particular, grid management system 240 refers to the management environment which creates a grid by linking computing systems into a heterogeneous network environment characterized by sharing of resources through grid services.

According to an advantageous of the invention, grid management system 240 includes a grid service for receiving bid requests for potential grid job submissions, calculating an expected workload requirement for the potential grid job submission, calculating a price for the expected workload requirement, and returning a bid to the client indicating the availability of resource and price for the resources for the potential grid job submission. In addition, grid management system 240 includes multiple additional grid services for providing automated control of a grid job in a closed-loop path through the grid environment, as will be further described.

Referring now to FIG. 3, a block diagram illustrates one example of an architecture that may be implemented in a grid environment. As depicted, an architecture 300 includes multiple layers of functionality. As will be further described, the present invention is a process which may be implemented in one or more layers of an architecture, such as architecture 300, which is implemented in a grid environment, such as the grid environment described in FIG. 2. It is important to note that architecture 300 is just one example of an architecture that may be implemented in a grid environment and in which the present invention may be implemented. Further, it is important to note that multiple architectures may be implemented within a grid environment.

Within the layers of architecture 300, first, a physical and logical resources layer 330 organizes the resources of the systems in the grid. Physical resources include, but are not limited to, servers; storage media, and networks. The logical resources virtualize and aggregate the physical layer into usable resources such as operating systems, processing power, memory, I/O processing, file systems, database managers, directories, memory managers, and other resources.

Next, a web services layer 320 provides an interface between grid services 310 and physical and logical resources 330. Web services layer 320 implements service interfaces including, but not limited to, Web Services Description Language (WSDL), Simple Object Access Protocol (SOAP), and eXtensible mark-up language (XML) executing atop an Internet Protocol (IP) or other network transport layer. Further, the Open Grid Services Infrastructure (OSGI) standard 322 builds on top of current web services 320 by extending web services 320 to provide capabilities for dynamic and manageable Web services required to model the resources of the grid. In particular, by implementing OGSI standard 322 with web services 320, grid services 310 designed using OGSA are interoperable. In alternate embodiments, other infrastructures or additional infrastructures may be implemented a top web services layer 320.

Grid services layer 310 includes multiple services, wherein the multiple services interacting with one another implement grid management system 240. For example, grid services layer 310 may include grid services designed using OGSA, such that a uniform standard is implemented in creating grid services. Alternatively, grid services may be designed under multiple architectures. Grid services can be grouped into four main functions. It will be understood, however, that other functions may be performed by grid services.

First, a resource management service 302 manages the use of the physical and logical resources. Resources may include, but are not limited to, processing resources, memory resources, and storage resources. Management of these resources includes scheduling jobs, distributing jobs, and managing the retrieval of the results for jobs. Resource management service 302 monitors resource loads and distributes jobs to less busy parts of the grid to balance resource loads and absorb unexpected peaks of activity. In particular, a user may specify preferred performance levels so that resource management service 302 distributes jobs to maintain the preferred performance levels within the grid.

Second, information services 304 manages the information transfer and communication between computing systems within the grid. Since multiple communication protocols may be implemented, information services 304 manages communications across multiple networks utilizing multiple types of communication protocols.

Third, a data management service 306 manages data transfer and storage within the grid. In particular, data management service 306 may move data to nodes within the grid where a job requiring the data will execute. A particular type of transfer protocol, such as Grid File Transfer Protocol (GridFTP), may be implemented.

Finally, a security service 308 applies a security protocol for security at the connection layers of each of the systems operating within the grid. Security service 308 may implement security protocols, such as Open Secure Socket Layers (SSL), to provide secure transmissions. Further, security service 308 may provide a single sign-on mechanism, so that once a user is authenticated, a proxy certificate is created and used when performing actions within the grid for the user.

Multiple services may work together to provide several key functions of a grid computing system. In a first example, computational tasks are distributed within a grid. Data management service 306 may divide up a computation task into separate grid services requests of packets of data that are then distributed by and managed by resource management service 302. The results are collected and consolidated by data management system 306. In a second example, the storage resources across multiple computing systems in the grid are viewed as a single virtual data storage system managed by data management service 306 and monitored by resource management service 302.

An applications layer 340 includes applications that use one or more of the grid services available in grid services layer 310. Advantageously, applications interface with the physical and logical resources 330 via grid services layer 310 and web services 320, such that multiple heterogeneous systems can interact and interoperate.

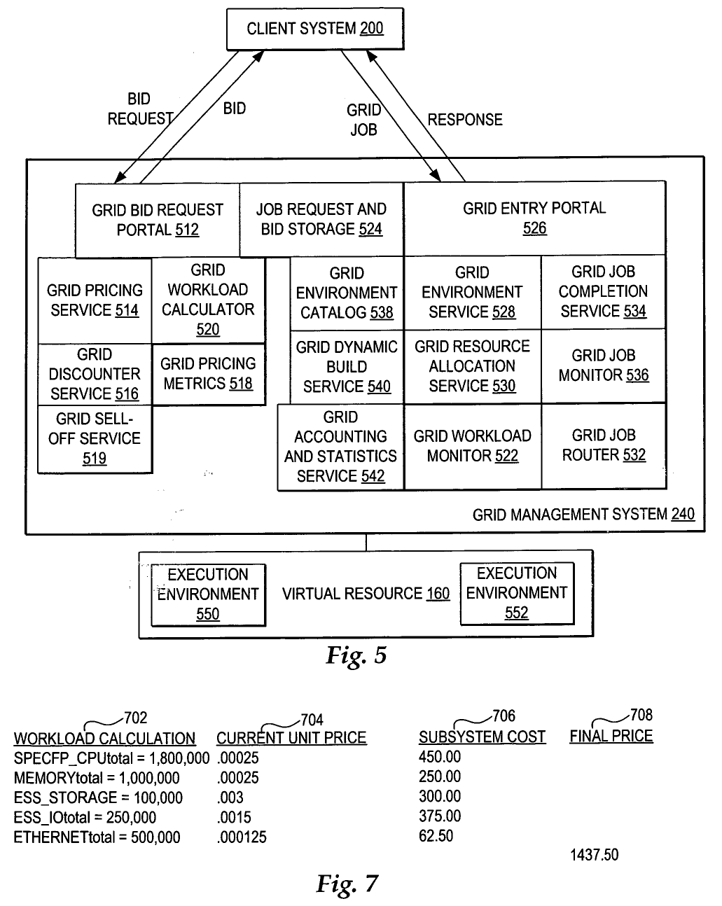

Referring now to FIG. 5, there is depicted a block diagram of an automated closed loop grid management system for handling bid requests and grid jobs in accordance with the present invention. As depicted, grid management system 240 includes multiple grid services. Grid management system 240 may include a central grid manager (not depicted) that coordinates the communication between each of the grid services. Alternatively, the grid services may directly communicate with each other within the communication system enabled by grid management system 240.

As depicted, grid management system 240 includes a grid bid request portal 512 that receives virtual job requests, or bid requests, from client systems inside or outside of grid environment 150, such as client system 200. In addition, grid bid request portal 512 may receive bid requests from other grid management systems or grid vendors. Grid bid request portal 512 may function as a grid service and may facilitate multiple bid request entry points.

Grid bid request portal 512 may store bid requests in job request and bid storage 524 for use in tracking the bid request and bid provided for a potential job submission. In particular, job request and bid storage 524 may store a bid request and bid for a limited period of time depending on the size of the storage medium and the number of bid requests received on average over a particular time period.

A bid request may include multiple required characteristics of the potential grid job. For example, the bid request may include characteristics that specify the pricing constraints for a grid job, the time limits for the grid job, eligibility of the grid job for capacity on demand resources, eligibility of the grid job for distribution or sell-off to other grid vendors, limitations on resource usage, job completion requirements, software platform class requirements, hardware platform class requirements, transport mechanism requirements for the grid job, the size of data accesses required for the grid job, and the job performance requirements. It will be understood that additional grid job characteristics and requirements may be included in the bid request that inform grid management system 240 about the potential grid job.

In addition, grid bid request portal 512 interfaces with a grid workload calculator 520 that may function as a grid service. In particular, a grid workload calculator 520 may access a grid workload monitor 522 that monitors the current workload on virtual resource 160 or a selection of resource nodes within virtual resource 160. Grid workload calculator 520 may compare the current workload with past workloads to predict future workloads at particular periods of time or on particular selections of resource nodes within virtual resource 160. In addition, grid workload calculator 520 may calculate an estimated workload factor on grid resources for the bid request, based on the characteristics of the grid job described in the bid request. In one example, a workload factor may indicate the estimated load on multiple resource subsystems based on the bid request and the current and estimated availability of the resource subsystems. For example, the workload factor may indicate the number of CPU cycles that grid workload calculator 520 estimates the potential job will required based on the bid request. In another example, the workload factor may indicate the resources which must be included in a resource node allocated for the grid job. In another example, the workload factor may include a number calculated to represent on a scale of impact on all or a selection of resources by the potential grid job. In yet another example, U.S. patent application Ser. No. 10/______ (Attorney Docket Number END920040039US1), herein incorporated by references, describes how grid workload calculator 520 calculates workload factors based on the combination of job characteristics.

Grid workload calculator 520 may pass the workload factor to a grid pricing service 514. Grid pricing service 514 then determines whether grid management system 240 can handle the potential grid job, and if so, calculates a price for handling the grid job. In particular, grid pricing service 514 may access a grid discounter service 516, grid pricing metrics module 518, and grid sell-off service 519 to calculate a price for handling the grid job, as will be further described with reference to FIG. 6.

Grid bid request portal 512 compiles the workload calculations and pricing calculations into a bid response and controls storage of the bid response in job request and bid storage 524 and distribution of the bid response to client system 200.

A grid entry portal 526 receives grid jobs from client system 200, or other grid management systems and grid environments. In one embodiment, grid entry portal 526 accesses the bid request and bid response for the grid job from job request and bid storage 524 and distributes the bid request and bid with the grid job throughout the grid services of grid management system 240. Grid entry portal 526 may distribute and load balance grid jobs across multiple physical servers providing grid management system 240. Further, grid entry portal 526 may be distributed across multiple physical servers and may function as a grid service.

A grid environment service 528 coordinates access of resource nodes for an incoming grid job. In one example, grid environment service 528 calls a grid resource allocation service 530 to control the actual allocation of resource nodes that grid environment service 528 determines should be accessible for an incoming grid job. If the types of resource nodes designated by grid environment service 528 are not available, then grid resource allocation service 530 may direct a grid dynamic build service 540 to build the resource nodes required for the execution environment for the grid job.

Execution environment 550 and execution environment 552 are examples of groupings of resource nodes allocated for use by a particular grid job or group of grid jobs from among the resources logically referred to as virtual resource 160. It will be understood virtual resource 160 may include any number of execution environments and that resources may overlap between execution environments. In addition, it will be understood that the resource nodes allocated to execution environments 550 and 552 may be redistributed to alternate execution environments. Further, it will be understood that the resource nodes allocated to execution environments 550 and 552 may include resource nodes that are built specifically for allocation in one of the execution environments.

Once resource nodes are allocated to an execution environment for the incoming grid job, a grid job router 532 routes the grid job to the designated resource nodes of the execution environment within virtual resource 160. In one example, grid job router 532 may interact with a grid service that tests and verifies the allocated resource nodes first to ensure that the resource nodes are able to handle the grid job. For example, U.S. patent application Ser. No. 10/______ (Attorney Docket Number AUS920040571US1) describes a grid modules that tests and verifies allocated grid resource nodes for compliance with required standards and errors.

A grid job monitor 536, in conjunction with grid workload monitor 522, monitors job completion. In particular, grid workload monitor 522 monitors the workload applied to resource nodes within virtual resource 160. Grid job monitor 536 determines which portions of the monitored workload results of grid workload monitor 522 to attribute to each grid, job. Thus, grid job monitor 536 is able to monitor the progress of a particular job, using the monitored workload, and determine whether the grid job executing is meeting performance requirements and other characteristics described for the grid job. If a grid job executing is not meeting performance requirements or other characteristics described for the grid job, grid job monitor 536 may access other grid services, such as grid sell-off service 519 or grid resource allocation service 530 to request redirecting the grid job to other resources or adding additional resource nodes to handle the grid job. In addition, grid job monitor 536 may interact with an error detection module (not depicted) that detects whether the grid job is executing with any degradation or errors in the execution environment. If an error or degradation is detected, grid job monitor 536 may respond by redirecting the grid job to other resources or adding additional resource nodes to bolster the execution environment.

A grid job completion manager 534 ensures proper completion of each grid job. In particular, grid job completion manager 534 detects from grid job monitor 536 when the grid job is complete and receives the response or result, but may also communicate with other modules to ensure that the grid job is complete. Further, grid job completion manager 534 may update a billing service (not depicted) with the workload usage characteristics of the grid job upon completion so that the billing service may generate a bill for client system 200 for the service provided.

Additionally, once the grid job is completed, grid environment manager 528 may capture and store an image of the execution environment in a grid environment catalog 538. In particular, grid environment manager 528 may update the stored environment image if the current execution environment is already stored in grid environment catalog 538. If the execution environment is not already stored in grid environment catalog 538, then grid environment manager 528 may first decide whether to store the execution environment image based on whether it is likely that the execution environment will be needed again in the future. In particular, grid environment manager 528 may determine the likelihood that the execution environment will be needed again in the future by viewing the bid request for the grid job that used the execution environment and historical data gathered about execution environments used within the grid environment.

In one embodiment, when grid environment manager 528 receives an incoming grid job from grid entry portal 526, grid dynamic build service 540 may access the grid environment catalog 538 to access the catalog entry for the execution environment needed for the incoming grid job, if a catalog entry already exists. By accessing catalogued images for the execution environment, grid resource allocation manager 530 can then quickly rebuild resources with the catalogued images.

With reference now to FIG. 6, there is depicted a block diagram of a grid pricing service in accordance with the method, system, and program of the present invention. In one embodiment, grid pricing service 514 calculates pricing based on as granular of units as possible. Thus, preferably, grid workload calculator 520 calculates workload factors in a small as unit as possible and calculates workload factors for each the type of resource subsystem within a resource node. For example, if possible, workload calculator 520 calculates the workload factor for use of a memory subsystem in bytes, or an even smaller unit, if possible. Cost calculator 606 then calculates the cost per unit for each workload factor for each resource subsystem. For example, cost calculator 606 calculates the cost per byte of memory estimated for a potential job.

In addition, as illustrated, grid pricing service 514 includes a conversion controller 602. Conversion controller 602 receives the workload factors calculated for a potential grid job and may convert the workload factors from one format into a customer requested format before cost calculator 606 calculates the cost per unit. For example, grid workload calculator 520 returns CPU usage in cycles and grid pricing service 514 calculates pricing based on the cycles, but the client requests hourly pricing. Thus, conversion controller 602 would convert the CPU usage workload factor calculation from the cycle basis to an hourly basis. Other examples of common or standard metric units used when describing resource use include, but are not limited to, database access specified by database records read and written and network data specified by packets read and written. In one embodiment, conversion controller 602 accesses the conversion equation from a translation table provided by the client or accessible within grid environment 150. In another embodiment, conversion controller 602 accesses an archiving manager within grid environment 150 to determine whether the conversion equation was previously used and stored for future use. It will be understood that conversion controller 602 may convert pricing to a customer requested format included in a particular bid request or specified in general for bid requests for a particular grid client.

Next, metrics access controller 604 controls access to grid pricing metrics 518. Grid pricing metrics 518 maintain the costs per unit for each type of resource subsystem. It will be understood that the costs per unit for each type of resource subsystem described in grid pricing metrics 518 may fluctuate based on demand for resources, availability of resources, failure rates of resources, and other factors that effect the value of the resources.

In addition, grid pricing service 514 may include or access contract data 610. Contract data 610 includes the specifications for contracts made with particular clients by a grid vendor to process grid jobs at set prices, such as setting the price per unit for particular subsystem usage by grid jobs. In another example, an existing contract may set the price per unit for a particular client if the estimated workload availability of the grid vendor exceeds a particular limit. It will be understood that additional contract limitations, that set pricing requirements for a particular grid job, type of grid job, or grid jobs from a particular client, may be included in contract data 610.

Further, grid pricing service 514 may include a discount access controller 608. Discount access controller 608 may access grid discounter 518, which calculates discounting of pricing for a bid request. In one example, grid discounter 518 may lower a price according to multiple criteria. For example, if the grid jobs submitted by a particular client exceed a particular threshold or if the grid job requests a quantity of resources that exceeds a threshold, then grid discounter 518 may lower the price. It will be understood that grid discounter 518 may apply additional types of discounting criteria, that the discounting criteria may apply to the total price for a potential job submission or to the cost of particular resource subsystems, and that the discounting criteria may be specified by grid job, grid job type, or client, for example.

In addition, grid pricing service 514 may include a sell-off access controller 612. Sell-off access controller 612 may access grid sell-off service 519, which controls the sell-off of a grid job to an alternate grid vendor or grid environment. In particular, sell-off service 519 may query other grid environments for pricing and route the grid job to a particular grid environment for processing. In one embodiment, a bid request must authorize sell-off for sell-off service 519 to request pricing bids from other grid environments. In addition, in one embodiment, grid pricing service 514 determines that grid environment 150 does not include sufficient grid resources to accommodate the grid job described by a bid request and decides to query availability and pricing from other grid environments via grid sell-off service 519.

It is important to note that cost calculator 606 may determine that the pricing for the job does not meet the pricing requirements of the bid request and return a no bid response. In addition, cost calculator 606 may calculate a bid response with an exception to the bid request, such as returning a bid response with a price for completing the potential job in seventy minutes, rather than the requested sixty minutes or returning a bid response with a price including a sell-off of the grid job to another grid environment.

Referring now to FIG. 7, there is depicted an illustrative example of a price calculation for a bid request in accordance with the method, system, and program of the present invention. As depicted, grid pricing service 514 receives the workload factors calculated by grid workload calculator 520 and illustrated at reference numeral 702. In the example, grid workload calculator 520 calculated the units of CPU usage, based on the Standard Performance Evaluation Corporation floating point standard (SPECfp), however, then converted the SPECfp based pricing into hourly pricing. In particular, in the example, the platform has a SPECfp rating of 1000 operations per second, and grid workload calculator 520 estimates the grid job will take 30 minutes. Therefore, hourly pricing would require 1000 operations per second for 1800 seconds (or 30 minutes), multiplied by the current unit pricing, illustrated at reference numeral 704. It will be understood by one with skill in the art that the SPECfp standard is a benchmark that measures a processor's performance and the CPU's interaction with main memory and cache.

Additionally, the memory total (MEMORYtotal) is priced per unit of memory, and in the example, the grid job is estimated to require 1 GM of memory, or 1,000,000 units. The Enterprise Storage Server (ESS) storage space (ESS_STORAGE) is priced per unit of storage, and in the example, the grid job is estimated to require 10 MB of storage space and the total input/output operations (ESS_IOtotal) is estimated for the grid job at 250,000. (Enterprise Storage Server is a registered trademark of International Business Machines Corporation) In addition, the grid job is estimated to require a total of 500,000 Ethernet packets (ETHERNETtotal). It will be understood that multiple types and brands of memory, storage space, and network resources may be available and measurable at a small unit of granularity.

As illustrated at reference numeral 706, a cost for use of each subsystem, including CPU usage, memory usage, storage space usage, I/O usage, and Ethernet usage, is calculated based on the workload calculation multiplied by the current unit price. Then, grid pricing service 514 calculates a final price, as illustrated at reference numeral 708, by adding all the subsystem costs.

In addition, although not depicted, grid pricing service 514 may adjust the final price by discounts for use of a particular quantity of units of a subsystem or if a job is submitted by a client who has submitted a particular number of grid jobs within a particular period of time. In addition, grid pricing service 514 may adjust the final price by the pricing agreed to in a contract with the client submitting the grid job.

With reference now to FIG. 8, there is depicted a high level logic flowchart of a process and program for controlling receipt and response to bid requests for a potential grid job submission to a particular grid environment in accordance with the method, system, and program of the present invention. As illustrated, the process starts at block 800 and thereafter proceeds to block 802. Block 802 depicts receiving a bid request for a potential job submission. Next, block 804 depicts a determination whether the potential job is a repeat of a previously submitted bid request or grid job. In particular, the grid bid request portal compares the current bid request with stored job requests and bid storage to determine if pricing for the same job has already been made. If the potential job is a repeat, then the process passes to block 806. Block 806 depicts returning the current price stored for the job workload, and the process ends. Alternatively, at block 804, if the bid request is not a repeat of a previously priced job, then the process passes to block 808. Block 808 depicts sending the bid request characteristics to the workload calculator. Next, block 810 depicts determining the total workload requirement for the bid request as calculated by the workload calculator, and the process passes to block 812.

Block 812 depicts determining the selection of available resources for the bid request base on the total workload requirement. Next, block 814 depicts a determination whether the available resources have the capacity to meet the total workload requirement. In particular, the grid bid request portal may access other grid management system modules, such as the grid environment manager, to determine which resources are available and to determine whether those resources have the capacity to meet the total workload requirement. If the available resources do not have the capacity to meet the total workload requirement, then the process passes to block 815. Block 815 depicts adding an exception to the potential bid response to indicate what resources are available, and the process passes to block 816. Otherwise, at block 814, if the available resources do have the capacity to meet the total workload requirement, then the process passes to block 816. Block 816 depicts calculating a total workload factor for the bid request based on the resource availability and performance. In particular, the workload calculator may determine the total workload factors for each subsystem or for the combined subsystems. In addition, in particular, the total workload factors are advantageously calculated to as fine of granularity of unit as possible, so that the cost can then be calculated based on unit usage, rather than just flat rates. Then, block 818 depicts submitting the price data and calculated workload factors to the grid pricing service. Thereafter, block 820 depicts responding to the bid request with the pricing data decided by the grid pricing service, and the process ends.

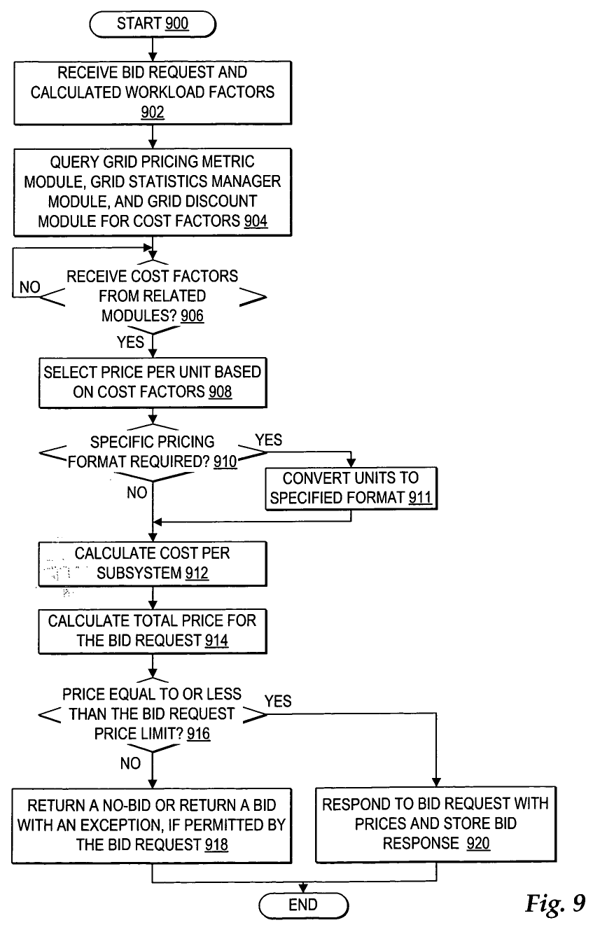

Referring now to FIG. 9, there is depicted a high level logic flowchart of a process and program for automatically determining a price for a potential job described in a bid request received by a grid vendor in accordance with the method, system, and program of the present invention. As depicted, the process starts at block 900 and thereafter proceeds to block 902. Block 902 depicts receiving the bid request and calculated workload factors for the bid request. Next, block 904 depicts querying the grid pricing metric module, grid statistics manager module, grid discount service, and grid sell-off service for cost factors. In one example, a grid statistics manager module stores historical data about the grid system, such as data about previously processed grid jobs, previous pricing, and previous sell-offs. Thereafter, block 906 depicts a determination whether cost factors are received. Once cost factors are received, then the process passes to block 908.

Block 908 depicts selecting the price per unit based on cost factors. Next, block 910 depicts a determination whether a specific pricing format is required in the bid request or for the client submitting the bid request. If a specific pricing format is not required, then the process passes to block 912. If a specific pricing format is required, then the process passes to block 911. Block 911 depicts converting the workload calculation units to a specified format, and the process passes to block 912.

Block 912 depicts calculating a cost per subsystem by multiplying the cost per unit by the number of units for each subsystem. Next, block 914 depicts calculating the total price for the bid request. Thereafter, block 916 depicts a determination whether the price, total by subsystem, is equal to or less than the bid request price limits. In particular, the price limit may specify a total cost price limit or price limits by subsystem. If the price is equal to or less than the bid request price limits, then the process passes to block 920. Block 920 depicts responding to the bid request with prices and storing the bid response, and the process ends. Otherwise, at block 916, if the price is not equal to or less than the bid request price limits, then the process passes to block 918. Block 918 depicts returning a no-bid or returning a bid with an exception if permitted by the bid request and acceptable to the grid vendor, and the process ends.

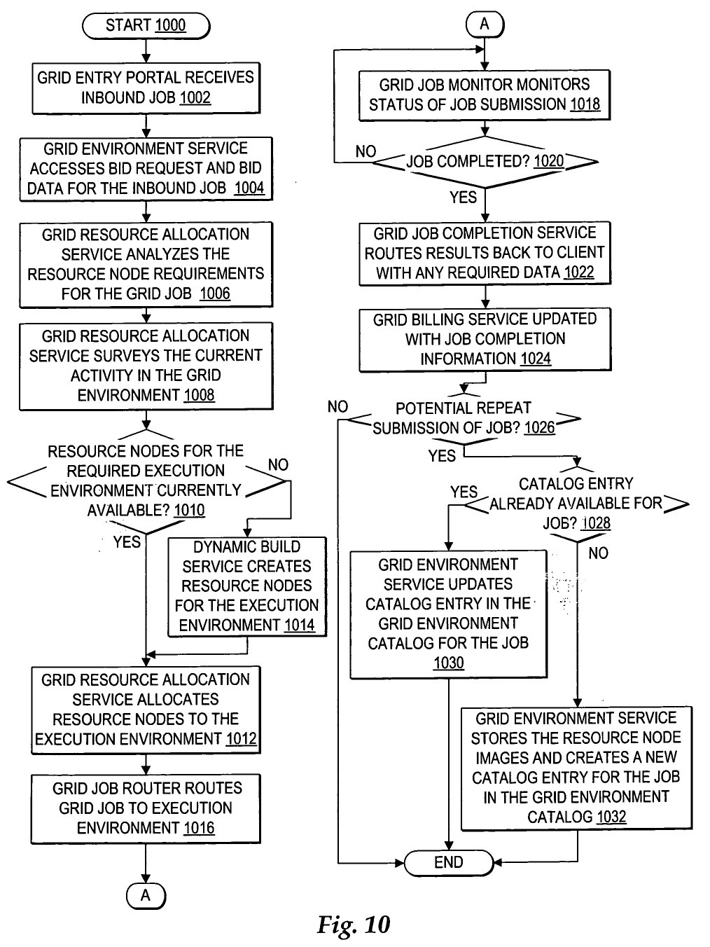

With reference now to FIG. 10, there is depicted a high level logic flowchart of a process and program for providing automated, closed-loop management of a grid job received at a grid management system in accordance with the method, system, and program of the present invention. As depicted, the process starts at block 1000 and thereafter proceeds to block 1002. Block 1002 depicts a grid entry portal receiving the inbound grid job. Next, block 1004 depicts a grid environment service accessing the bid request and previously agreed to bid for handling the inbound grid job. Thereafter, block 1006 depicts a grid resource allocation service analyzing the resource node requirements for the grid job and block 1008 depicts the grid resource allocation service surveying the current activity in the grid environment to identify available resource nodes and the process passes to block 1010.

Block 1010 depicts grid resource allocation service determining whether the resource nodes required for an execution environment are currently-available. If the resource nodes required for an execution environment are not currently available, then the process passes to block 1014. Block 1014 depicts the dynamic build service creating the resource nodes required for the execution environment, and the process passes to block 1012. Otherwise, at block 1010, if the resource nodes required for an execution environment are currently available, then the process passes to block 1012.

Block 1012 depicts the grid resource allocation service allocating a selection of available resource nodes to the execution environment. Next, block 1016 depicts the grid job router routing the grid job to the execution environment. Thereafter, block 1018 depicts the grid job monitor monitoring the status of the job submission, and the process passes to block 1020.

Block 1020 depicts a determination whether the job is completed. If the job is not completed, then the process returns to block 1018. If the job is completed, then the process passes to block 1022. In particular, the grid job completion service determines whether a job has completed based on indicators such as detecting a final result or response and receiving an indicator from the grid job monitor that the job is complete.

Block 1022 depicts the grid job completion service routing the results back to the client with any required data. Next, block 1024 depicts the updating the grid billing service with the job completion information for future billing. Thereafter, block 1026 depicts a determination whether the job has potential to be repeated. Multiple factors may indicate whether a job has the potential to be repeated including, but not limited to, the bid request for the job indicating multiple repetitions, the client's likelihood to send repeat jobs, and whether the job is of a type that is typically repeated. If the job does not have the potential of a repeat submission, then the process ends. If the job does have the potential of a repeat submission, then the process passes to block 1028.

Block 1028 depicts a determination whether a catalog entry for the job is already available in the grid environment catalog. If a catalog-entry for the job is already available, then the process passes to block 1030. Block 1030 depicts the grid environment service updating the catalog entry in the grid environment catalog for the job, and the process ends. Otherwise, at block 1028, if a catalog entry for the job is not already available, then the process passes to block 1032. Block 1032 depicts the grid environment service recording the resource node images and creating in a new catalog entry for the job in the grid environment catalog, and the process ends.

While the invention has been particularly shown and described with reference to a preferred embodiment, it will be understood by those skilled in the art that various changes in form and detail may be made therein without departing from the spirit and scope of the invention.

What is claimed is:

1. A computer-implemented method for calculating a price for a potential grid job submission, comprising:
enabling receipt of a bid request from a client system for a potential grid job submission via a grid environment submission portal, wherein said bid request specifies a plurality of characteristics of said potential grid job submission;
calculating a predicted workload factor for said potential grid job submission based on said plurality of characteristics of said potential grid job submission, wherein said predicted workload factor is based on at least one type of granular unit indicating usage of at least one type of resource subsystem; and
calculating a price for said potential grid job submission based on said predicted workload factor and a cost per said at least one granular unit, such that said price is available for inclusion in an automated response to said bid request.

2. The computer-implemented method according to claim 1 for calculating a price for a potential grid job submission, further comprising:
calculating said cost per said at least one granular unit based on current and predicted workload on a plurality of resources available in said grid environment.

3. The computer-implemented method according to claim 1 for calculating a price for a potential grid job submission, further comprising:
determining whether said potential grid job submission is eligible for discounting within said grid environment; and
responsive to determining that said potential grid job submission is eligible for discounting, adjusting said price by a discount amount.

4. The computer-implemented method according to claim 3 for calculating a price for a potential grid job submission, wherein said eligibility for discounting for said potential grid job submission is calculated based on at least one from among a type of said potential grid job submission, said predicted workload factor for said potential grid job submission, and a volume of grid jobs submitted by a client submitting said potential grid job submission.

5. The computer-implemented method according to claim 1 for calculating a price for a potential grid job submission, further comprising:
adjusting said price for said potential grid job submission based on a contract setting said cost per said at least one granular unit for a client submitting said bid request.

6. The computer-implemented method according to claim 1 for calculating a price for a potential grid job submission, wherein calculating said price for said potential grid job submission based on said predicted workload factor and a cost per said at least one granular unit, further comprises:
calculating a plurality of subprices, wherein each of said plurality of subprices is calculated for a predicted workload requirement for each of a plurality of subsystems described in said predicted workload factor; and
accumulating said price for said potential grid job submission from said plurality of subprices.

7. The computer-implemented method according to claim 1 for calculating a price for a potential grid job submission, wherein calculating said price for said potential grid job submission based on said predicted workload factor and a cost per said at least one granular unit, further comprises:
converting said predicted workload factor from said at least one type of granular unit into a second type of granular unit specified by a client submitting said bid request.

8. A system for calculating a price for a potential grid job submission, comprising:
an automated grid management system for controlling a plurality of resources within a grid environment;
said automated grid management system further comprising:
means for enabling receipt of a bid request from a client system for a potential grid job submission via a grid environment submission portal, wherein said bid request specifies a plurality of characteristics of said potential grid job submission;
means for calculating a predicted workload factor for said potential grid job submission based on said plurality of characteristics of said potential grid job submission, wherein said predicted workload factor is based on at least one type of granular unit indicating usage of at least one type of resource subsystem; and
means for calculating a price for said potential grid job submission based on said predicted workload factor and a cost per said at least one granular unit, wherein said price is available for inclusion in an automated response to said bid request.

9. The system according to claim 8 for calculating a price for a potential grid job submission, said automated grid management system further comprising:
means for calculating said cost per said at least one granular unit based on current and predicted workload on a plurality of resources available in said grid environment.

10. The system according to claim 8 for calculating a price for a potential grid job submission, said automated grid management system further comprising:
means for determining whether said potential grid job submission is eligible for discounting within said grid environment; and
means, responsive to determining that said potential grid job submission is eligible for discounting, for adjusting said price by a discount amount.

11. The system according to claim 10 for calculating a price for a potential grid job submission, wherein said eligibility for discounting for said potential grid job submission is calculated based on at least one from among a type of said potential grid job submission, said predicted workload factor for said potential grid job submission, and a volume of grid jobs submitted by a client submitting said potential grid job submission.

12. The system according to claim 8 for calculating a price for a potential grid job submission, said automated grid management system further comprising:
means for adjusting said price for said potential grid job submission based on a contract setting said cost per said at least one granular unit for a client submitting said bid request.

13. The system according to claim 8 for calculating a price for a potential grid job submission, wherein said means for calculating said price for said potential grid job submission based on said predicted workload factor and a cost per said at least one granular unit, further comprises:
means for calculating a plurality of subprices, wherein each of said plurality of subprices is calculated for a predicted workload requirement for each of a plurality of subsystems described in said predicted workload factor; and
means for accumulating said price for said potential grid job submission from said plurality of subprices.

14. The system according to claim 8 for calculating a price for a potential grid job submission, wherein said means for calculating said price for said potential grid job submission based on said predicted workload factor and a cost per said at least one granular unit, further comprises:
means for converting said predicted workload factor from said at least one type of granular unit into a second type of granular unit specified by a client submitting said bid request.

15. A computer program product, residing on a computer readable medium, for calculating a price for a potential grid job submission, comprising:
means for enabling receipt of a bid request from a client system for a potential grid job submission via a grid environment submission portal, wherein said bid request specifies a plurality of characteristics of said potential grid job submission;
means for calculating a predicted workload factor for said potential grid job submission based on said plurality of characteristics of said potential grid job submission, wherein said predicted workload factor is based on at least one type of granular unit indicating usage of at least one type of resource subsystem; and
means for calculating a price for said potential grid job submission based on said predicted workload factor and a cost per said at least one granular unit.

16. The computer program product according to claim 15 for calculating a price for a potential grid job submission, further comprising:
means for calculating said cost per said at least one granular unit based on current and predicted workload on a plurality of resources available in said grid environment.

17. The computer program product according to claim 15 for calculating a price for a potential grid job submission, further comprising:
means for controlling a determination whether said potential grid job submission is eligible for discounting within said grid environment; and
means, responsive to determining that said potential grid job submission is eligible for discounting, for controlling an adjustment of said price by a discount amount.

18. The computer program product according to claim 15 for calculating a price for a potential grid job submission, further comprising:
means for controlling an adjustment of said price for said potential grid job submission based on a contract setting said cost per said at least one granular unit for a client submitting said bid request.

19. The computer program product according to claim 15 for calculating a price for a potential grid job submission, wherein said means for calculating said price for said potential grid job submission based on said predicted workload factor and a cost per said at least one granular unit further comprises:
means for calculating a plurality of subprices, wherein each of said plurality of subprices is calculated for a predicted workload requirement for each of a plurality of subsystems described in said predicted workload factor; and
means for accumulating said price for said potential grid job submission from said plurality of subprices.

20. The computer program product according to claim 15 for calculating a price for a potential grid job submission, wherein said means for calculating said price for said potential grid job submission based on said predicted workload factor and a cost per said at least one granular unit, further comprises:
means for converting said predicted workload factor from said at least one type of granular unit into a second type of granular unit specified by a client submitting said bid request.

21. A computer-implemented method for closed-loop automated management of a grid job received at a grid environment, said method comprising:
responsive to receiving a grid job at a grid portal of said grid environment from a client, accessing a bid request and bid previously agreed to for said grid job;
analyzing said bid for said grid job to determine a resource node requirement for said grid job;
surveying a current activity level in said grid environment to detect whether a selection of available resource nodes meeting said resource node requirement are available;
responsive to detecting said selection of available resource nodes meeting said resource node requirement, allocating said selection of resource nodes for said grid job;
routing said grid job to said allocated selection of resource nodes for said grid job;
monitoring a status of said grid job according to the workload detected from said allocated selection of resource nodes;
responsive to verifying a completion of said grid job, routing at least one result of said grid job to said client via said grid portal, such that automated management in a closed-loop path is provided for each grid job received via said grid portal.

22. The computer-implemented method according to claim 21 for closed-loop automated management of a grid job received at a grid environment, further comprising:
responsive to verifying a completion of said grid job, updating a billing service with said workload detected from said allocated selection of resource nodes.

23. The computer-implemented method according to claim 21 for closed-loop automated management of a grid job received at a grid environment, further comprising:
recording an image of said resource node requirement in an environment catalog, wherein responsive to receiving a next grid job matching said grid job, said image of said resource node requirement is retrievable.

24. The computer-implemented method according to claim 21 for closed-loop automated management of a grid job received at a grid environment, further comprising:
responsive to detecting that said selection of available resource nodes are unavailable, building at least one resource node required to make said selection of available resource nodes.

25. A system for closed-loop automated management of a grid job received at a grid environment, said system comprising:
an automated grid management system for controlling a path of each grid job from among a plurality of grid jobs through a plurality of resources within a grid environment;
said automated grid management system further comprising:
means, responsive to receiving a grid job at a grid portal of said grid environment from a client, for accessing a bid request and bid previously agreed to for said grid job;
means for analyzing said bid for said grid job to determine a resource node requirement for said grid job;
means for surveying a current activity level in said grid environment to detect whether a selection of available resource nodes meeting said resource node requirement are available;
means, responsive to detecting said selection of available resource nodes meeting said resource node requirement, for allocating said selection of resource nodes for said grid job;
means for routing said grid job to said allocated selection of resource nodes for said grid job;
means for monitoring a status of said grid job according to the workload detected from said allocated selection of resource nodes;
means, responsive to verifying a completion of said grid job, for routing at least one result of said grid job to said client via said grid portal.

26. The system according to claim 25 for closed-loop automated management of a grid job received at a grid environment, said automated grid management system further comprising:
means, responsive to verifying a completion of said grid job, for updating a billing service with said workload detected from said allocated selection of resource nodes.

27. The system according to claim 25 for closed-loop automated management of a grid job received at a grid environment, said automated grid management system further comprising:
means for recording an image of said resource node requirement in an environment catalog, wherein responsive to receiving a next grid job matching said grid job, said image of said resource node requirement is retrievable.

28. The system according to claim 25 for closed-loop automated management of a grid job received at a grid environment, said automated grid management system further comprising:
means, responsive to detecting that said selection of available resource nodes are unavailable, for building at least one resource node required to make said selection of available resource nodes.

29. A computer program product, residing on a computer readable medium, for closed-loop automated management of a grid job received at a grid environment, comprising:
means, responsive to receiving a grid job at a grid portal of said grid environment from a client, for controlling retrieval of a bid request and bid previously agreed to for said grid job;
means for analyzing said bid for said grid job to determine a resource node requirement for said grid job;
means for controlling a survey of a current activity level in said grid environment to detect whether a selection of available resource nodes meeting said resource node requirement are available;
means, responsive to detecting said selection of available resource nodes meeting said resource node requirement, for controlling allocation of said selection of resource nodes for said grid job;
means for controlling routing of said grid job to said allocated selection of resource nodes for said grid job;
means for monitoring a status of said grid job according to the workload detected from said allocated selection of resource nodes;
means, responsive to verifying a completion of said grid job, for controlling routing of at least one result of said grid job to said client via said grid portal.

30. The computer program product according to claim 29 for closed-loop automated management of a grid job received at a grid environment, said automated grid management system further comprising:
means, responsive to verifying a completion of said grid job, for updating a billing service with said workload detected from said allocated selection of resource nodes.

31. The computer program product according to claim 29 for closed-loop automated management of a grid job received at a grid environment, said automated grid management system further comprising:
means for recording an image of said resource node requirement in an environment catalog, wherein responsive to receiving a next grid job matching said grid job, said image of said resource node requirement is retrievable.

32. The computer program product according to claim 29 for closed-loop automated management of a grid job received at a grid environment, said automated grid management system further comprising:
means, responsive to detecting that said selection of available resource nodes are unavailable, for building at least one resource node required to make said selection of available resource nodes.
